(19) United States
(12) Patent Application Publication
(10) Pub. No.: US 2021/0372630 A1
(43) Pub. Date: Dec. 2, 2021

(54) DUAL COOKING APPLIANCE

(71) Applicant: Team International Group of America Inc., Miami Gardens, FL (US)

(72) Inventor: Uri Murad, Hollywood (US)

(21) Appl. No.: 17/389,225

(22) Filed: Jul. 29, 2021

Related U.S. Application Data
(63) Continuation-in-part of application No. 17/176,838, filed on Feb. 16, 2021.
(60) Provisional application No. 63/062,541, filed on Aug. 7, 2020.
(60) Provisional application No. 62/982,999, filed on Feb. 28, 2020.

(51) Int. Cl. F24C 15/18; F24C 7/08; F24C 7/06; A47J 37/06

(52) U.S. Cl. CPC F24C 15/18; F24C 7/085; F24C 15/028; A47J 37/0641; F24C 7/062

(57) ABSTRACT

A cooking appliance is adapted to perform either as a single large fan-forced convection oven capable of cooking a larger food, or as two smaller independently-operable fan-forced convection ovens each capable of cooking smaller foods. Features of the cooking element arrangement provide faster, more efficient, and higher quality results regardless of the size and amount of food being cooked.

### FIELD OF THE INVENTION

The invention relates to cooking appliances. More specifically, it relates to countertop electric ovens, particularly having versatility to function as a single oven for cooking larger, or as one or more side-by-side independently-operable ovens for cooking smaller foods.

### BACKGROUND

Electric ovens are well-known and one common variety is the fan-forced convection oven. Fan-forced convection ovens include an air heater and a fan. The turbulence by the fan of the cooking air heated by the heater provides faster and more even cooking.

Air fryers are well-known and are an extreme form of fan-forced convection oven in which higher temperature air at a higher airflow rate is applied to oily food or food that has been coated in oil to brown the food in a manner that mimics the browning, crispiness, and flavor of deep frying, but without the mess, danger, and calories.

It is well known that fan-forced convection ovens are most efficient, cook faster, and cook food of a better quality when the oven's cooking cavity size and shape are proportional to the amount of food being cooked therein. When cooking a small portion of food in a large oven, heated airflow is hard to control the food is less evenly cooked and energy that would be best focused on cooking is wasted heating an mostly empty cooking chamber. Users who sometimes cook smaller portions and sometimes cook larger foods are therefore forced to purchase a large oven and a separate small oven individually to obtain optimal results, increasing cost, decreasing convenience. and requiring additional valuable storage and countertop space.

It is found through experience and experimentation that fan-forced convection ovens, which typically have only a single air heating element typically located in the top of the cooking chamber are prone to unheated hot air distribution. This is because, by the time the heated air reaches the underside of the food, its temperature has dropped. While the drop is small, it is not insignificant, as it results in the top surfaces of the cooked food being more cooked, crispier, and more browned than the bottom surfaces.

There exists the need to provide, and such may be an object of the invention, an apparatus which can function as a single oven for cooking larger foods, or as one or more adjacent independently-operable ovens for cooking smaller foods.

There exists the need to provide, and such may be an additional object of the invention, such an apparatus which can be converted between these functions quickly and simply.

There exists the need to provide, and such may be an additional object of the invention, for such an apparatus to function as a more effective and efficient fan-forced convection oven.

There exists the need to provide, and such may be an additional object of the invention, for such an apparatus to cook food evenly, quickly, and efficiently regardless of the size or amount of the food portion.

There exists the need to provide, and such may be an additional object of the invention, such an apparatus with is adapted to recognize which of these functions it is arranged to perform for the desired cooking requirement and to operate accordingly.

Further needs and objects of the invention will become apparent upon a review of the following disclosure of an exemplary embodiment.

### SUMMARY OF THE INVENTION

The invention may be embodied in or practiced using a cooking appliance which can selectively perform as a larger fan-forced convection oven for cooking larger foods, or as a plurality of smaller independently-operable fan-forced convection ovens for cooking a plurality of smaller foods.

The invention may be embodied in or practiced using a cooking appliance including; a housing defining a major cooking cavity, a plurality of cooking elements, the plurality of access doors, and the plurality less one of user-installable and removable separation panels. The separation panels may be adapted to separate portions of the major cooking cavity into a plurality of minor cooking cavities, each including one or more of the cooking elements and each accessible through one of the access doors. The cooking elements may each include an air heating element and a fan for turbulizing the air heated thereby, and a controller for operation thereof.

The appliance may include means to recognize if and which of the separation panels are in place, and to communicate that one or more of the controllers which may control functions of the associated cooking elements including, but not limited to, one or more of temperature, heating wattage, cooking time, and fan speed. The functions of each cooking element may be controlled independently of the others.

The appliance may include means to recognize when no separator panels are in use, and to then synchronize the functions of all controllers so that the appliance operates as a single larger fan-forced convection oven employing all cooking elements in equal function and the major cooking cavity. The synchronized controllers may control functions of the cooking elements as a single major cooking element of the major cooking cavity including, but not limited to, one or more of temperature, heating wattage, cooking time, and fan speed.

The appliance may be adapted to allow operation of all independently operated controllers such that the total wattage does not exceed a maximum wattage and to allow operation of the synchronized controllers such that the wattage is the maximum wattage

The access doors may be adapted for independent operation so that only one of the cooking cavities may be and needs to be opened during insertion or removal of food to be or having been cooked therein.

Further features and aspects of the invention are disclosed with more specificity in the Description and Drawings provided herein and showing exemplary embodiments of the invention.

### BRIEF DESCRIPTION OF THE DRAWINGS

Exemplary embodiments of fan-forced convection ovens in accordance with or useful in practicing the invention are shown in the accompanying Drawings, of which;

FIG. 1 is a perspective view of a first oven;

FIG. 2 is a front view of the oven of FIG. 1 in its closed state;

FIG. 3 is side cross-sectional view of the oven of FIG. 1 taken al line 3-3 of FIG. 2;

FIG. 4 is a top view of the oven of FIG. 1 in its closed state;

FIG. 5 is a front cross-sectional view of the oven of FIG. 1 taken at line 5-5 of FIG. 4;

FIG. 6 is a side view of the oven of FIG. 1;

FIG. 7 is a rear view of the oven of FIG. 1;

FIG. 8 is an exploded view of the oven of FIG. 1;

FIG. 9 is a partial exploded view of the oven of FIG. 1;

FIG. 10A is a top view of the oven of FIG. 1 with its left door opened;

FIG. 10B is a top view of the oven of FIG. 1 with its right door opened;

FIG. 10C is a top view of the oven of FIG. 1 with both doors opened;

FIG. 11 is a perspective view of a second oven; and

FIG. 12 is a front cross-sectional view of the oven of FIG. 11 taken at line 12-12 of FIG. 11.

### DESCRIPTION OF AN EXEMPLARY EMBODIMENT

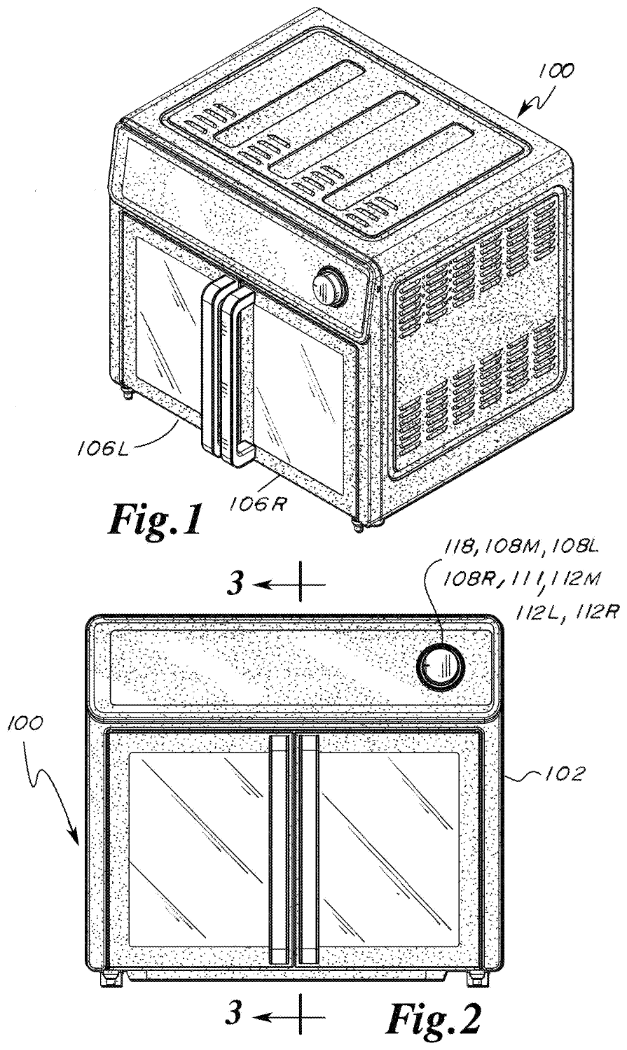

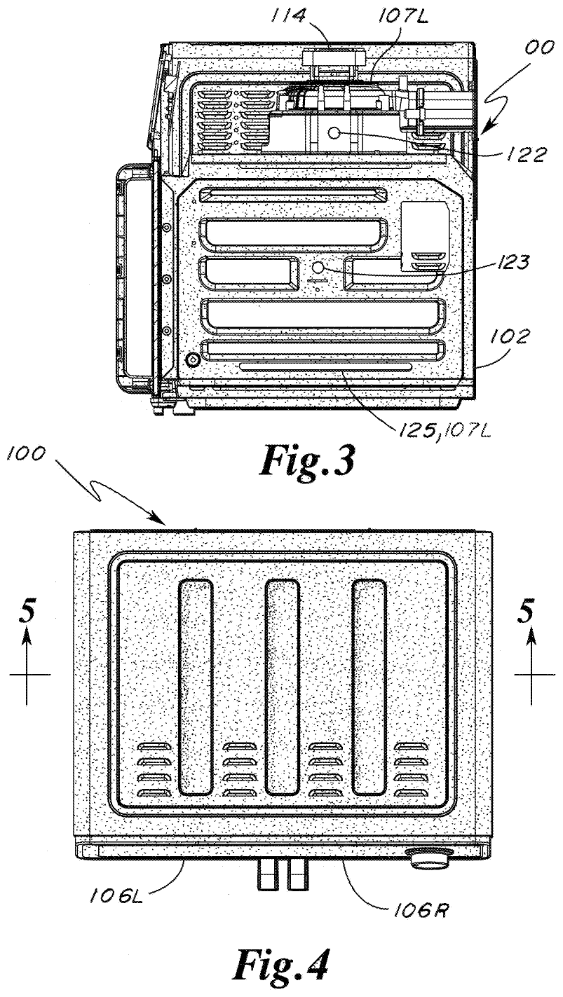

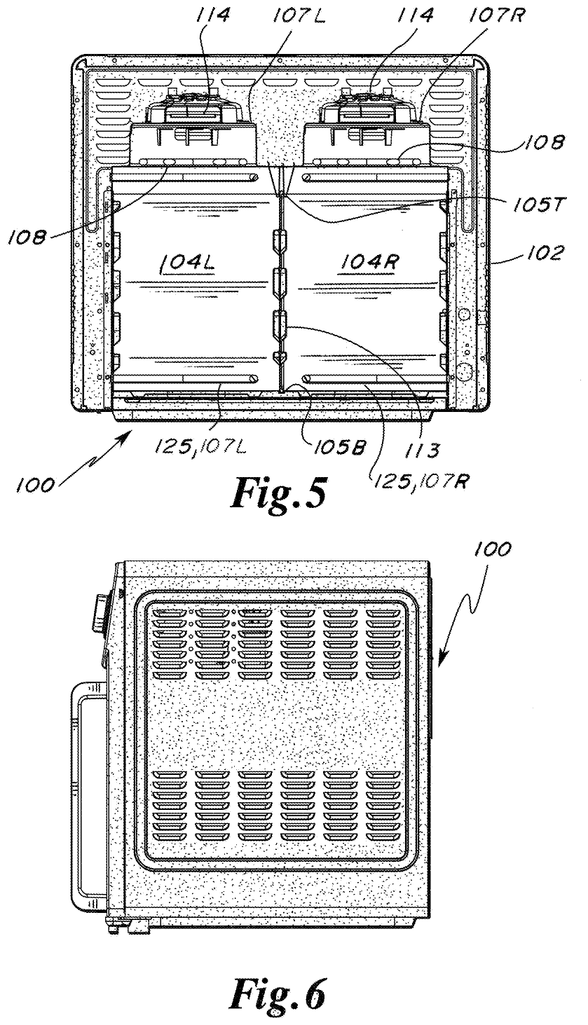

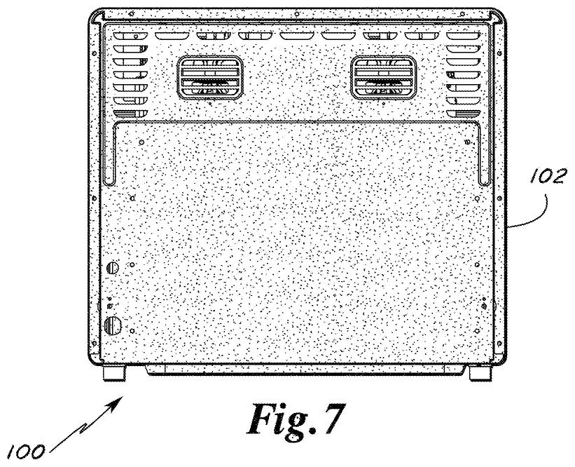

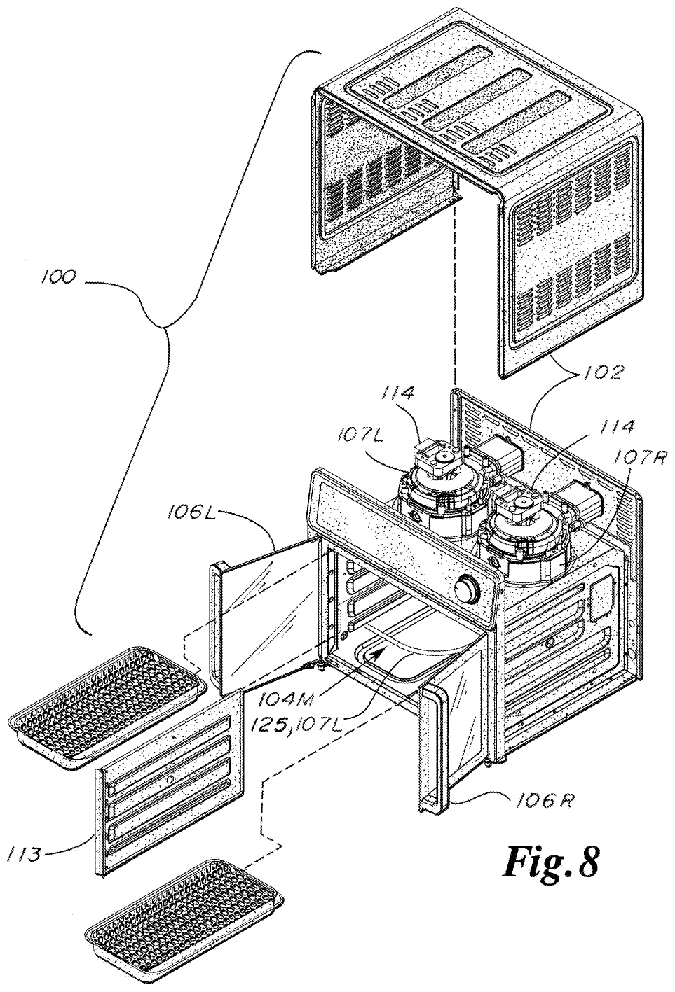

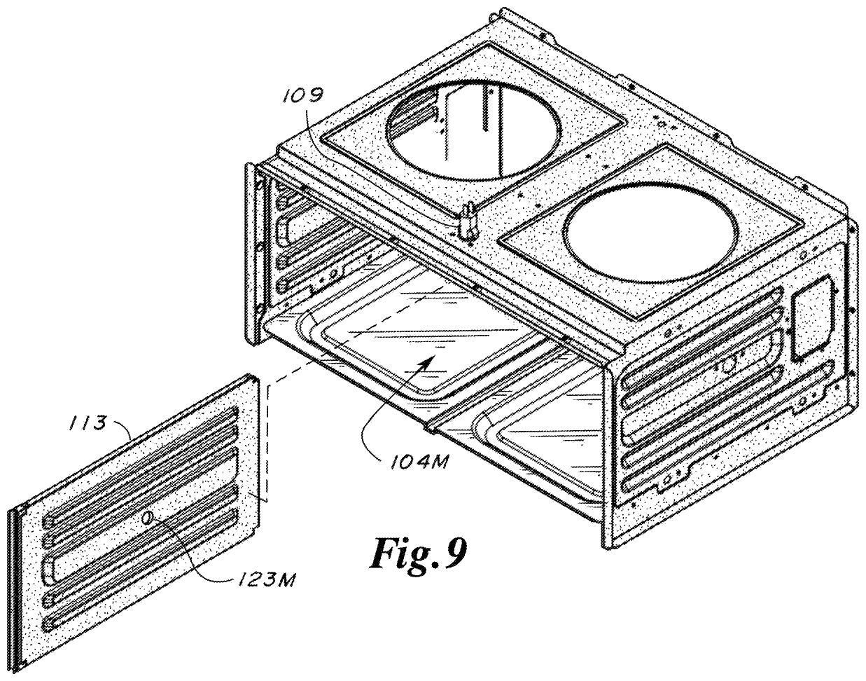

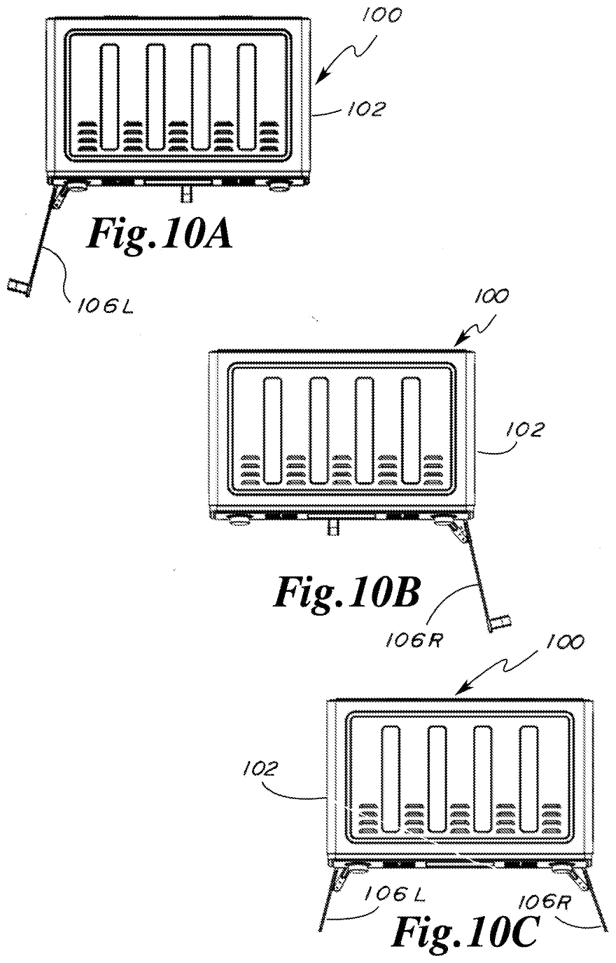

Referring to FIGS. 1 through 10C there is shown a first exemplary cooking appliance, here embodied as electrical countertop fan-forced convection oven 100. A housing 102 defines a major cooking cavity 104M. Access doors 106L and 106R allow selective access to the cooking cavity. A first electrical cooking element 107L is disposed at the top left side of the cooking cavity. A second electrical cooking element 107R is disposed at the top right side of the cooking cavity.

Each cooking element includes a top electrical air heating element 108, an electric blower (or fan) 114, a bottom electrical heating element 125 and an NTC thermostat 122 (although any equivalent type of thermostat may be substituted). Each blower is arranged to agitate (turbulize) air within the cooking cavity that has been heated by the associate air heating elements or may operate while one or both of the associated heating elements are off to agitate unheated air, such as during a cool-down period.

A separation panel 113 is removably disposable within the major cooking cavity to divide the major cooking cavity into left and right minor cooking cavities 104L and 104R, respectively. The thermostat associated with each of the minor cooking cavities monitors the temperature therewithin. The separation panel fits into the cooking cavity by sliding into grooves 105T and 105B in the top and bottom, respectively, of the cooking cavity atop.

The cooking cavities are equipped with means to receive and rotate a rotisserie (not shown). Those means include receivers 123 on each inner side wall and in the separator panel, receiver 123M in the separator panel, and a motor (not shown) behind the left inner side wall. A longer rotisserie may be inserted when the separator is not present for use in the major cooking cavity, or a shorter rotisserie may be inserted into just the left cooking cavity for use therein when the separator panel is used. Rotisseries are well known so, for brevity, further description thereof is not felt to be required here.

The insertion of or absence of the separation panel is sensed by microswitch (or sensor) 109. A controller arrangement 118 includes a major control 108M to operate both cooking elements and the rotisserie (if selected), a left control 108L to operate only the left cooking element, a right control 108R to operate only the right cooking element, an input interface 111, a major control timer 112M to time the operation of both cooking elements and the rotisserie (if selected) together, a left control timer 112L to time the operation of only the left cooking element, and a right control timer 112R to time the operation of only the right cooking element.

When the microswitch senses the absence of the separation plate and communicates that to the controller arrangement, the major control, major control timer, and rotisserie (if selected) are enabled. When the microswitch senses the insertion of the separation plate and communicates that to the controller arrangement, the left and right controls and control timers are enabled.

The input interface is adapted to manually receive cooking parameters for the controls from a user, including such function as cooking temperature, heating element wattages, cooking time, rotisserie operation, etc., and to independently energize the cooking elements according thereto.

During the enablement of the major controller, both cooking elements and the rotisserie (if selected) are arranged to function equally (synchronized), at the same cooking temperature, heating element wattages, cooking time, etc . . . thereby cooperating as a singular major cooking element (107R+107L), and the major controller is arranged to average the temperatures sensed by both thermostats.

During the enablement of the minor controllers, both cooking elements are arranged to function independently, so that the cooking temperatures, heating element wattages, and cooking times can be set independently of each other to thereby cook two distinct foods differently, one in each minor cooking cavity and each minor controller is arranged to cooperate with only its associated thermostat.

The controls may energize the cooking elements in a variety of manners to provide the required cooking parameters. For instance the heating elements may be cycled on and off to obtain the desired cooking temperature, or the heating element wattages may be continuously varied to obtain the desired cooking temperature, or the blower speed(s) may be varied to obtain the desired level(s) of air turbulence.

The bottom heating elements ensure that the temperature of the air is even from top to bottom throughout the cooking cavities, regardless of whether operation of the minor or major cooking cavities.

Countries and regions typically limit the amount of power that an electrical appliance of this type may draw (1800W in the US), so in this case the wattage consumption of each minor cooking element is limited to 1800W when only that minor cooking element is in use, and the wattage consumption of each minor cooking element is limited to 900W when both minor cooking elements are in use only, thereby limiting the wattage consumption of the major cooking element to 1800W.

The left and right access doors allow the user to open only one of the cooking cavities as needed and to thereby avoid any effect on the other.

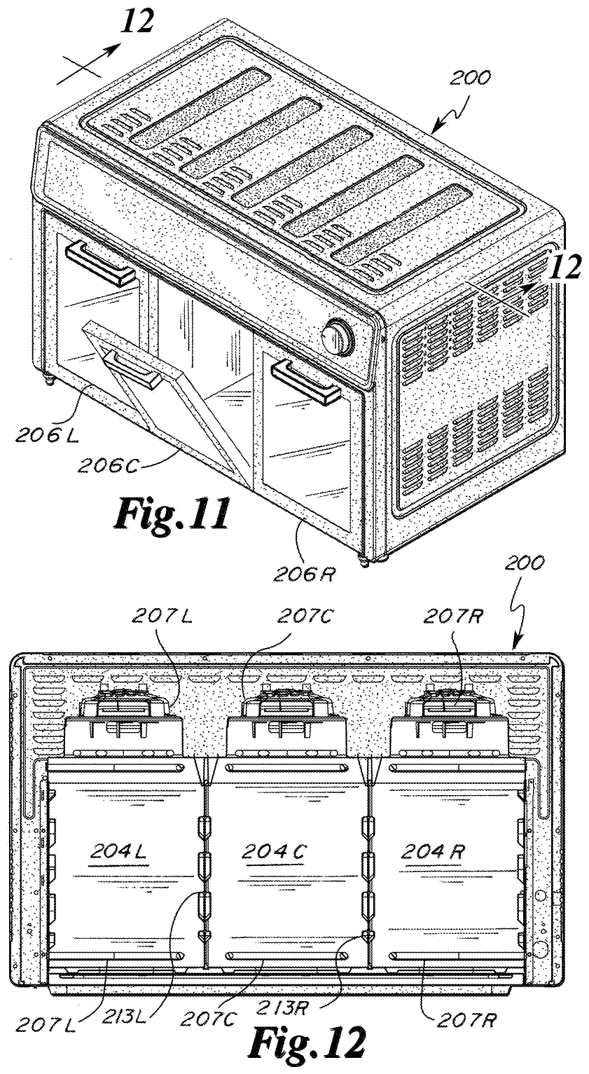

A second exemplary cooking appliance is shown in FIGS. 11 and 12 to demonstrate that the invention can be further practiced with more than two cooking cavities . . . in this case in a similar appliance 200 having three electrical cooking elements 207L, 207C and 207R, three minor cooking cavities 204L, 204C and 204R, two separator panels 213L and 213R, three downwardly-opening access doors 206L, 206C, and 206R. Construction and function not described follows the teachings of the first embodiment except in accordance with the number of cooking chambers of the particular design . . . undescribed components and functions being obviously increased as appropriate.

While the arrangements shown position the minor cavities in a horizontal side-by-side arrangement, it is also anticipated that the arrangement could a vertical top-to-bottom one.

And while the arrangements shown include fan-forced convection cooking elements to obtain fan-forced convection cooking, other types of elements/ovens may be substituted without escaping the boundaries of the invention. For instance, the concept could be similarly applied to an oven having radiant or tubular top heating elements without fans to obtain convection-only cooking.

While the invention has been shown and described with reference to specific exemplary embodiments, it should be understood by those skilled in the art that various changes in form and detail may be made without departing from the spirit and scope of the invention, and that the invention should therefore only be limited according to the following claims, including all equivalent interpretation to which they are entitled.

1. A cooking appliance adapted to perform either as a single large fan-forced convection oven capable of cooking foods, or as two smaller independently-operable fan-forced convection ovens each only capable of cooking smaller foods than the single large fan-forced convection oven, and comprising:
a housing defining the major cooking cavity including two independently operable cooking elements, two independently-operable access doors, and one user-installable and removable separation panel;
two independently-operable sub-controllers, each associated with one of the independently operable cooking elements; and
a major controller associated with both of the independently operable cooking elements; wherein the separation panel, when user-installed, is adapted to divide the major cooking cavity into two separate minor cooking cavities, each minor cooking cavity including one of the independently operable cooking elements and each minor cooking cavity being accessible through one of the access doors.

2. The cooking appliance of claim 1 wherein the independently operable cooking elements each include a top air heating element disposed within an upper portion of its associated minor cooking cavity and a bottom air heating element disposed within a lower portion of its associated minor cooking cavity both adapted to heat air within either the major cooking cavity or its associated one of the minor cooking cavities, and a fan adapted to turbulize the heated air within the major cooking cavity or that associated one of the minor cooking cavities.

3. The cooking appliance of claim 2 further comprising a separator panel sensor adapted to sense the presence the user-installed separator panel and adapted to sense the absence of the separator panel.

4. The cooking appliance of claim 3 wherein the sensor is in communication with one or both of the sub-controllers and with the major controller.

5. The cooking appliance of claim 4 in which each sub-controller controls functions of its associated independently operable cooking element including one or more of temperature, heating wattage, cooking time, and fan speed.

6. The cooking appliance of claim 5 in which the functions of each independently operable cooking element may be independently controlled of the functions of the other. Docket: KA-28

7. The cooking appliance of claim 6 wherein sensing of an absence of the separator panel by the separator panel sensor enables the major controller to cause the synchronization of the functions of both sub-controllers so that the appliance operates as the single large fan-forced convection oven employing the major cooking cavity and both of the independently operable cooking elements.

8. The cooking appliance of claim 7 wherein the synchronization of the functions of both sub-controllers causes the functions of both of the independently operable cooking elements equally as a singular major cooking element.

9. The cooking appliance of claim 8 wherein the functions of the singular major cooking element include one or more of temperature, heating wattage, cooking time, and fan speed.

10. The cooking appliance of claim 9 wherein the sub-controllers are adapted to limit individual wattage consumption by the independently-operable cooking elements when enabled, and the major controller is adapted to limit wattage consumption by the major cooking element when enabled, such that a total wattage consumption does not exceed a maximum wattage consumption.

11. The cooking appliance of claim 10 wherein the wattage consumption limit of the major cooking element is 1800W and the wattage consumption limit of each independently-operable cooking element is 900W.

12. The cooking appliance of claim 11 wherein each of the independently-operable access doors enables access to only its associated one of the cooking cavities. Docket: KA-28

13. A cooking appliance adapted to perform either as a major fan-forced convection oven capable of cooking foods, or as a first plurality of minor independently-operable fan-forced convection ovens each only capable of cooking smaller foods than the single large fan-forced convection oven, and comprising:
a housing defining the major cooking cavity including the first plurality of independently operable cooking elements, the first plurality of independently-operable access doors, and a second plurality, being one less than the first plurality, of user-installable and removable separation panels;
the first plurality of independently-operable sub-controllers, each associated with one of the first plurality of independently operable cooking elements; and
a major controller associated with all of the first plurality of independently operable cooking elements;
wherein each of the first plurality of separation panels, when user-installed, is adapted to divide the major cooking cavity into separate minor cooking cavities, each minor cooking cavity including one or more of the independently operable cooking elements and each minor cooking cavity being accessible through one of the access doors.

14. The cooking appliance of claim 13 wherein the independently operable cooking elements each include a top air heating element disposed within an upper portion of its associated minor cooking cavity and a bottom air heating element disposed within a lower portion of its associated minor cooking cavity, both adapted to heat air within either the major cooking cavity or its associated one of the minor cooking cavities, and a fan adapted to turbulize the heated air within the major cooking cavity or that associated one of the minor cooking cavities.

15. The cooking appliance of claim 14 further comprising the second plurality of separator panel sensors, each adapted to sense the presence of an associated one of the user-installed separator panels and adapted to sense the absence of that associated separator panel.

16. The cooking appliance of claim 15 wherein each sensor is in communication with two or more of the sub-controllers and with the major controller.

17. The cooking appliance of claim 16 in which each sub-controller controls functions of its associated independently operable cooking element including one or more of temperature, heating wattage, cooking time, and fan speed. Docket: KA-28

18. The cooking appliance of claim 17 in which the functions of each independently operable cooking element may be independently controlled of the functions of the others.

19. The cooking appliance of claim 18 wherein sensing of an absence of any of the separator panels by the separator panel sensors enables the major controller to cause the synchronization of the functions of all sub-controllers so that the appliance operates as the major fan-forced convection oven employing the major cooking cavity and all of the independently operable cooking elements.

20. The cooking appliance of claim 19 wherein the synchronization of the functions of all sub-controllers causes the functions of all of the independently operable cooking elements equally as a singular major cooking element.

21. The cooking appliance of claim 20 wherein the functions of the singular major cooking element include one or more of temperature, heating wattage, cooking time, and fan speed.

22. The cooking appliance of claim 21 wherein the sub-controllers are adapted to limit individual wattage consumption by the independently operable cooking elements when enabled, and the major controller is adapted to limit wattage consumption by the major cooking element when enabled, such that a total wattage consumption does not exceed a maximum wattage consumption.

23. The cooking appliance of claim 22 wherein the wattage consumption limit of the major cooking element is 1800W and the wattage consumption limit of each independently-operable cooking element is 1800W divided by the first plurality.

24. The cooking appliance of claim 23 wherein each of the independently-operable access doors enables access to only its associated one of the cooking cavities.
